(19) United States
(12) Patent Application Publication
(10) Pub. No.: US 2013/0318002 A1
(43) Pub. Date: Nov. 28, 2013

(54) RESOURCE MANAGEMENT PLAN CREATION DEVICE AND RESOURCE MANAGEMENT PLAN CREATION METHOD

(71) Applicants: Tomoe Tomiyama, Tokyo (JP); Tatsuhiro Sato, Tokyo (JP); Tomohito Takai, Tokyo (JP)

(72) Inventors: Tomoe Tomiyama, Tokyo (JP); Tatsuhiro Sato, Tokyo (JP); Tomohito Takai, Tokyo (JP)

(73) Assignee: Hitachi, Ltd., Tokyo (JP)

(21) Appl. No.: 13/983,942

(22) PCT Filed: Dec. 5, 2011
(86) PCT No.: PCT/JP2011/078031

§ 371 Date: Aug. 6, 2013

(30) Foreign Application Priority Data
Feb. 15, 2011 (JP) 2011-029279

(51) Int. Cl. G06Q 10/08

(52) U.S. Cl. CPC G06Q 10/08355
USPC 705/338

(57) ABSTRACT

A resource management plan creation support device reads in a travel schedule, represents, as one node, each path from an originating location to a terminating location of each leg included in a travel schedule that has been read in, and creates a network model by connecting together, using links, the legs over which consecutive travel is possible based upon the place and time. In addition, nodes representing auxiliary resources are added to the created network, and the network model is updated by adding links representing temporary usage of the auxiliary resources or temporary cessation of use of business-use resources. Also, by finding a path group encompassing each node of the network model so as to satisfy a pre-supplied condition (the condition of allocating resources to all of the legs), a management plan for resources which execute transport services is created.

### TECHNICAL FIELD

The present invention relates to a resource management plan creation support device, a resource management plan creation support method and a resource management plan creation support program, concretely relates to technique that enables creating a resource management plan in which work related to the maintenance and the management of resources in transport service and the regularity of resource allocation are considered.

### BACKGROUND OF THE INVENTION

In transport service such as a railroad and aviation, a maintenance work plan of resources such as a vehicle and an airframe used for operation is also required to be considered in parallel with the management of an operational schedule. For example, as for a railroad, a period of vehicular inspection is legally defined and inspection work is required to be regularly executed with the inspection period kept, efficiently allocating rolling stock to a train. Such a plan in consideration of the management of resources is hereinafter called a resource management plan.

In the resource management plan for the railroad, a vehicle allocated to a train is required to be selected out of massive combination, considering a characteristic of an individual vehicle such as a type and the performance of a vehicle, the timing of a shuttle at a station, the time of return to a car depot for inspection and others, and it is manually difficult work. However, the creation of the resource management plan for the railroad is not sufficiently systematized yet and manual creation depending upon experiences of experts is continued.

In consideration of such a situation, trial to automatically create a resource management plan is made. JP-A No. 2010-58771 and “Freight Locomotive Operation Arrangement Problem” when schedule is out of order written by Keisuke Sato and Naoto Fukumura, IPSJ SIG Notes 2009(19), 141-144, 2009-02-26 provide a means to recreate a resource management plan also in consideration of an inspection period based upon a train timetable changed to recover from disorder when the operation of trains is out of order. Further, JP-A No. 2005-259052 provide a means to find a location in which unscheduled inspection work can be executed based upon inquiry about the connection of trains and to create a resource management plan into which extraordinary inspection work is inserted. Further, JP-A No. 2003-154939 provide a means to accept a desirable pattern from a user about a shuttle of a train and a vehicle allocated to a train and to create a resource management plan in consideration of intention of a user about the connection of trains.

### SUMMARY OF INVENTION

When a resource management plan is created, it is important not only to meet characteristics of vehicles and an operational schedule but to secure the regularity (hereinafter called an operational pattern) of the operation of a vehicle. For example, in a case of a railroad, a vehicle for which the date of large-scale inspection approaches is left in a car depot all day before the inspection as a spare vehicle and a period for a stay as a spare vehicle so as to equalize travel distance and running days among plural vehicles is intentionally considered. Such regularity is an important element not only to execute maintenance work periodically but to enable usual maintenance work and usual vehicle storage work on the spot.

JP-A No. 2010-58771, JP-A No. 2005-259052 and “Freight Locomotive Operation Arrangement Problem” when schedule is out of order written by Keisuke Sato and Naoto Fukumura, IPSJ SIG Notes 2009(19), 141-144, 2009-02-26 have it as their objects to automatically create a vehicular management plan, however, the regularity of vehicular operation, for example, the regularity of the allocation of a vehicle to a train is not considered. JP-A No. 2003-154939 has a function to accept a desirable pattern from a user, however, a spare vehicle is considered the same as a business vehicle, and an operational pattern including spare operation cannot be handled.

Further, in a case of a spare vehicle, even if the spare vehicle is specially run, it is often an important condition to return the spare vehicle to a car depot on the same day. In the prior art, a condition to specify a location of such operational termination cannot be handled. Since a vehicle of another company is required to be returned to another company on the same day between companies that participate in reciprocal extension in principle, a condition of a location in which operation is finished can also be applied to a reciprocally extended vehicle.

Therefore, technique for creating a resource management plan in consideration of an operational pattern is provided below.

A resource management plan creation method includes the steps of:

reading operation schedule information of transport service;

generating nodes at least having a starting location, start time, a terminal location and termination time of a transportation course as an attribute in each of a plurality of transportation courses included in an operational schedule based upon the operation schedule information, generating a path that connects nodes representing the transportation course in which continuous operation is possible using the same transportation resource based upon the attribute of each node, and generating a network model of the transportation courses;

acquiring information related to spare resources, generating a spare resource node at least having a storage location and an available time zone of the corresponding spare resource as an attribute and adding the spare resource node to the network model and adding a path that connects a node representing an operational course in which operation is possible using the spare resource and the spare resource node based upon the attribute of the spare resource node and an attribute of another node configuring the network model to the network model;

extracting, from the network model, a combination of a plurality of paths in each of which one transportation resource or the spare resource is allocated to each node configuring the network model except the spare resource node; and

creating a management plan of transportation resources and spare resources by allocating the transportation resource or the spare resource to each of the plurality of paths configuring the extracted combination and outputting the management plan.

The resource management plan in consideration of the operational pattern including the operation of a spare vehicle and the regularity of maintenance work can be created. The resource management plan in consideration of the safety of work can be created by maintaining the regularity of work as much as possible.

### BRIEF DESCRIPTION OF DRAWINGS

FIG. 1 shows an example of the configuration of a resource management plan creation support device;

FIG. 2 is a flowchart showing an example of a procedure for processing basic operation of the resource management plan creation support device;

FIG. 3 shows an example of an operational schedule of a train;

FIG. 4 shows an example of a resource management plan of a vehicle;

FIG. 5(a) shows an example of a network model representing a resource management plan;

FIG. 5(b) shows an example of a network model representing operation for a spare;

FIG. 6 shows an example of the configuration of a history information record of a user and an example of data that belongs to the record;

FIG. 7(a) shows an example of a screen for accepting an operational pattern;

FIG. 7(b) shows an example of a screen for accepting an operational pattern;

FIG. 8 is a flowchart showing one example of a procedure for generating the network model;

FIG. 9 is a flowchart showing one example of a procedure for creating the resource management plan;

FIG. 10 shows an example of a network model representing a resource management plan;

FIG. 11 is a flowchart showing one example of a procedure for creating a resource management plan;

FIG. 12 shows an example of a screen for accepting an operational pattern; and

FIG. 13 shows an example of the configuration of a history information record of a user and an example of data that belongs to the record.

### DESCRIPTION OF EMBODIMENTS

Embodiments of the present invention will be described referring to the drawings using vehicular management in a railroad for an example below.

### First Embodiment

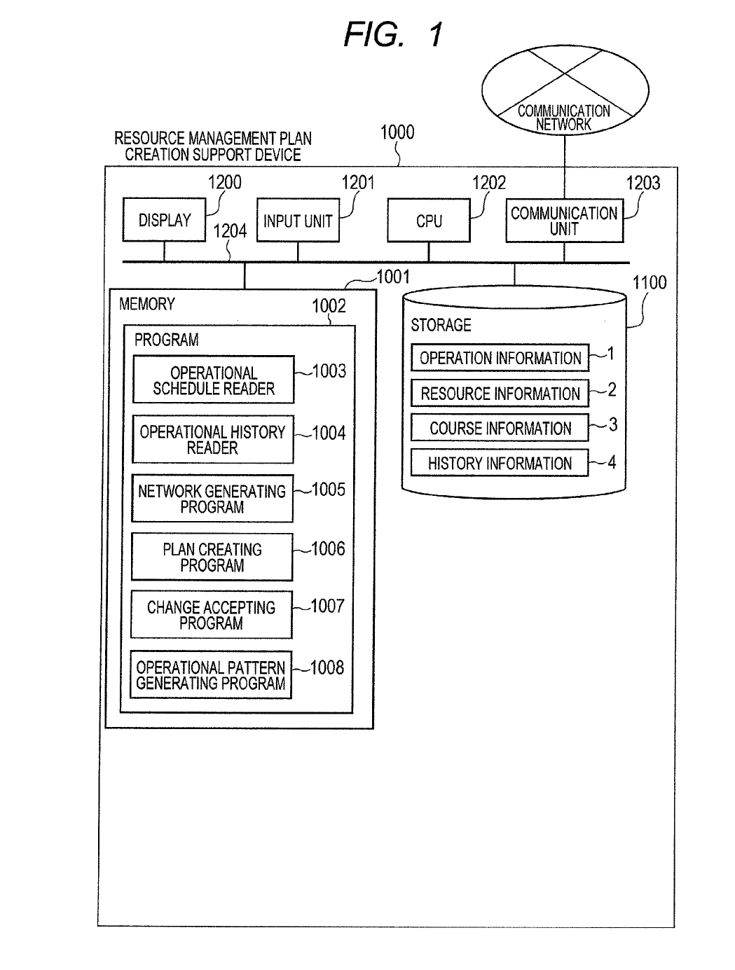

FIG. 1 is a block diagram showing an example of the configuration of a resource management plan creation support device. The resource management plan creation support device 1000 is configured by a memory 1001, a storage 1100, a display 1200, an input unit 1201, a central processing unit (CPU) 1202, a communication unit 1203 and a data bus 1204 that connects these.

The display 1200 is a display and others and displays information to a user such as an execution situation and a result of the execution of processing by the resource management plan creation support device 1000. The input unit 1201 is a unit for inputting an instruction to a computer such as a keyboard and a mouse and accepts input from a user. The central processing unit (CPU) 1202 executes various programs stored in the memory 1001. The communication unit 1203 exchanges various data and a command with another device via a local area network (LAN) and others. The storage 1100 stores various data for the resource management plan creation support device 1000 to execute processing. The memory 1001 holds various programs 1002 and temporary data for the resource management plan creation support device 1000 to execute processing.

In the storage 1100, resource information 2, course information 3, history information 4 and operation information 1 are stored.

The memory 1001 stores an operational schedule reader 1003, an operational history reader 1004, a network generating program 1005, a plan creating program 1006, a change accepting program 1007 and an operational pattern generating program 1008 as the program 1002.

The operational schedule reader 1003 reads operation information 1 stored in the storage 1100.

The operational history reader 1004 reads history information 4 of a user stored in the storage 1100.

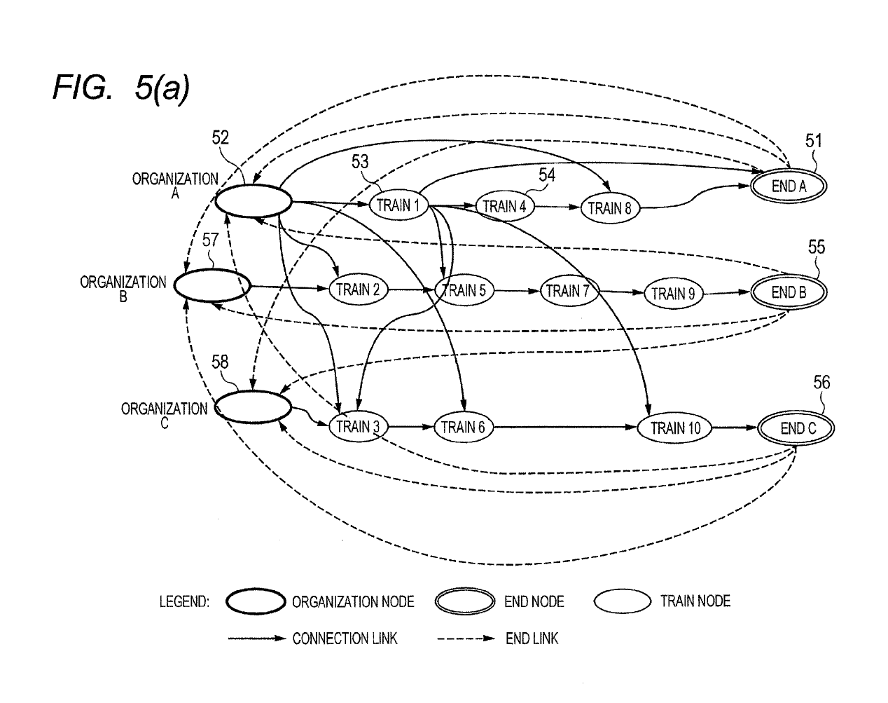

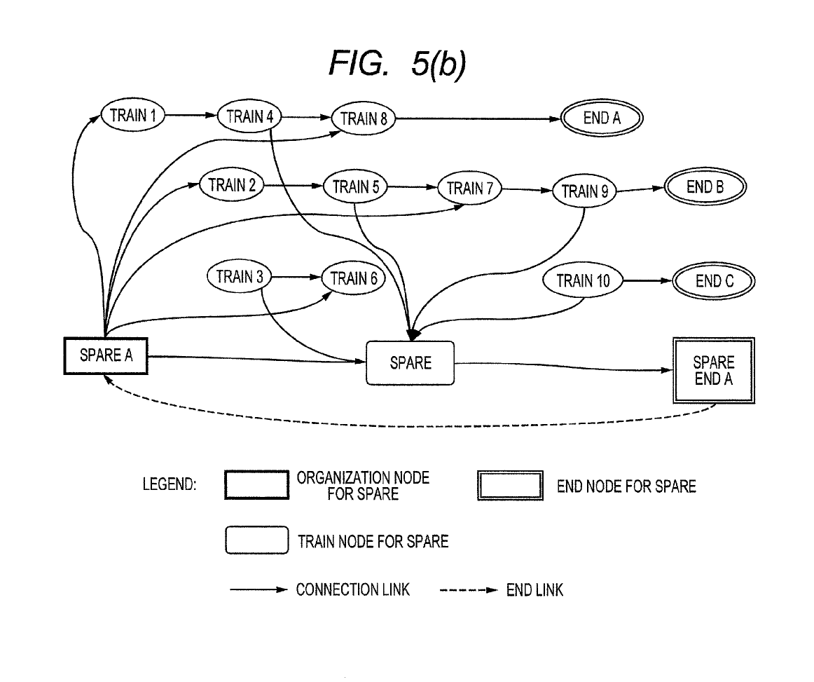

The network generating program 1005 generates a network model representing a resource management plan based upon the operation information read by the operational schedule reader 1003 and the history information read by the operational history reader 1004. Details of the network model will be described referring to FIG. 5.

The plan creating program 1006 creates a constraint based upon the network model generated by the network generating program 1005, creates a resource management plan so that the created constraint is met, and presents the created resource management plan to a user via the display 1200.

The change accepting program 1007 accepts a change for the resource management plan presented to the user by the plan creating program 1006 from the user via the input unit 1201.

The operational pattern generating program 1008 changes the network model generated by the network generating program 1005 based upon the history information 4 read by the operational history reader 1004 or the change accepted by the change accepting program 1007 and adds information representing a change location of the resource management plan to the history information 4.

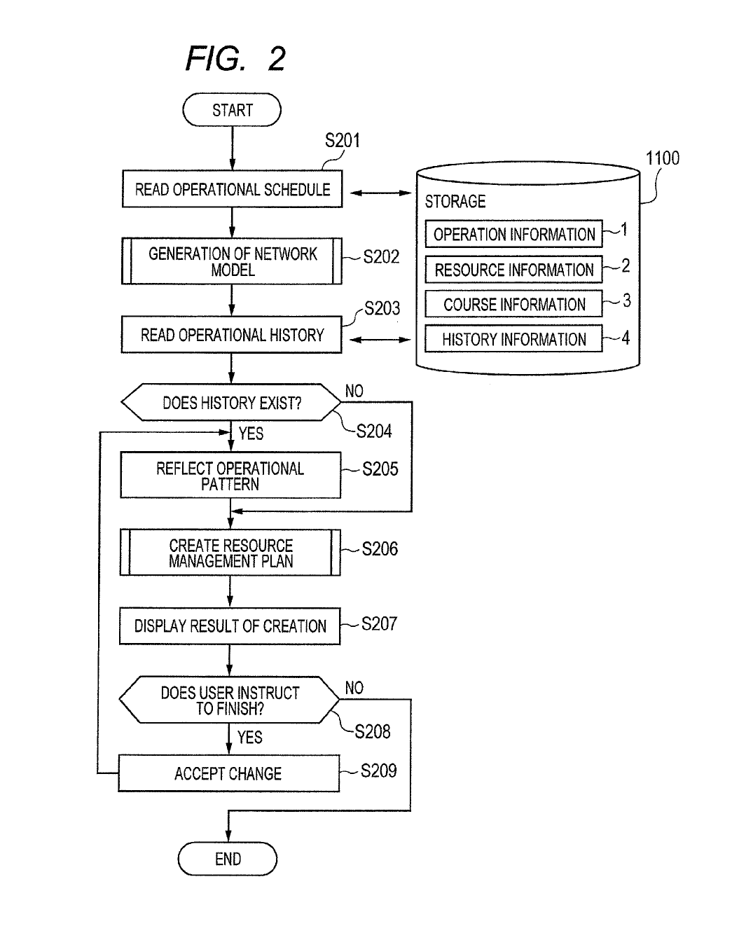

FIG. 2 is a flowchart showing an example of a basic operational procedure of the resource management plan creation support device 1000. First, an outline of the flowchart in relation to the operational procedure will be described.

The operational schedule reader 1003 reads operation information 1 stored in the storage 1100 (a step S201).

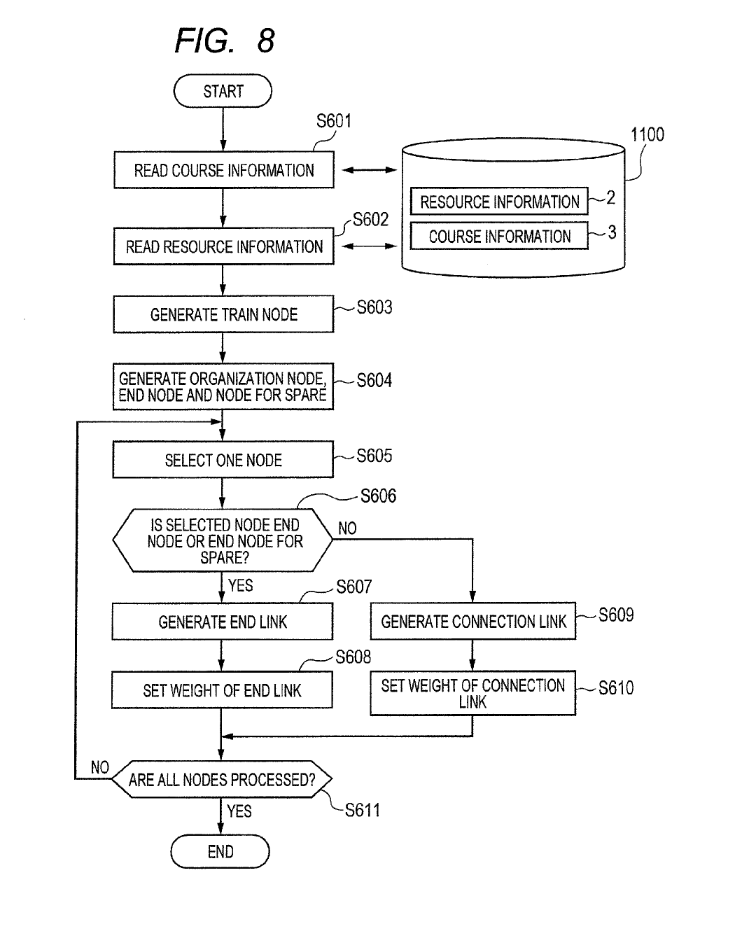

The network generating program 1005 generates a network model representing a resource management plan of transportation such as a vehicle based upon an operational schedule read in S201 (a step S202). The details of the generated network model will be described referring to FIG. 5 and the details of a method of generating the network model will be described referring to FIG. 8.

The operational history reader 1004 reads the history information 4 of a user stored in the storage 1100 (a step S203) and determines whether the history information exists or not (a step S204). When the history information exists, a process proceeds to the reflection of an operational pattern (a step S205) and when no history information exists, the process proceeds to the creation of a resource management plan (a step S206).

The operational pattern generating program 1008 changes the network model generated in S202 based upon operational history included in the history information read in S203 in a case of the continuation of S204 and changes a network model of the latest version based upon a change accepted in S209 in a case of the continuation of S209 (a step S205). A procedure for the change of the network model will be described in detail referring to FIG. 8 below.

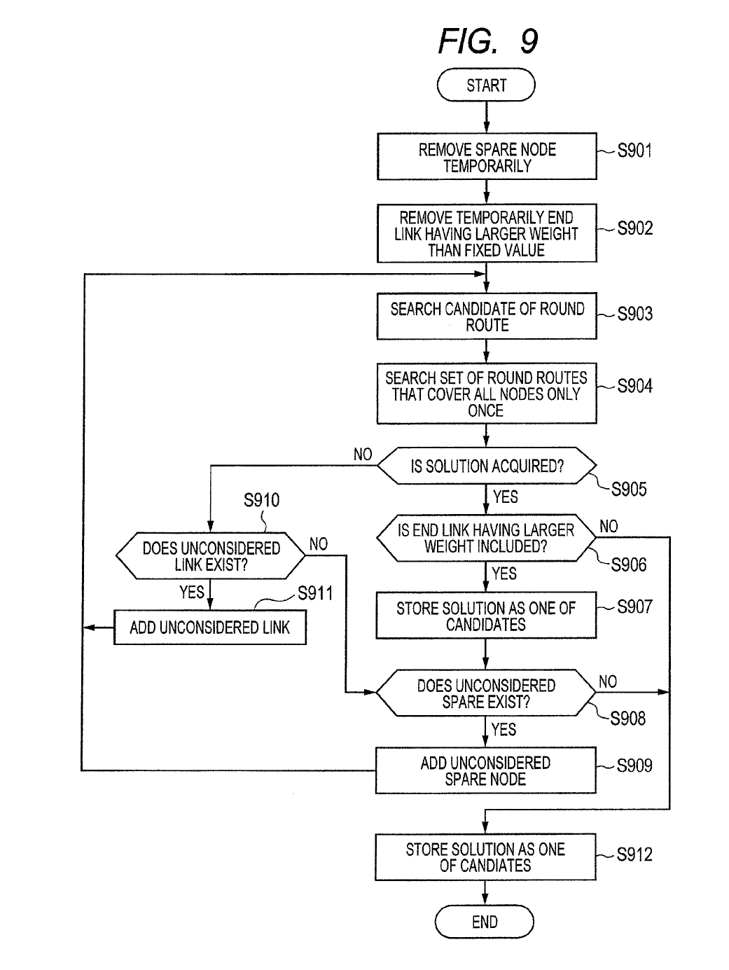

The plan creating program 1006 generates a mathematical model acquired by formulating the network model generated according to a series of procedures in S201 to S205 as a transportation plan problem and creates a resource management plan that meets a condition represented by the mathematical model (a step S206). The generated mathematical model and the plan creation procedure will be described in detail referring to FIG. 9 below.

The plan creating program 1006 presents a result of the resource management plan created in S206 to the user via the display 1200 (a step S207). At this time, when plural plans are created in S206, all the plans are displayed.

The plan creating program 1006 determines whether the user instructs to finish or not (a step S208), when the user instructs to finish, a series of processing is finished, and when the user does not instruct to finish, the process proceeds to the acceptance of a change to the result of the plan (a step S209).

The plan creating program 1006 accepts a change from the user to the result of the plan presented in S207 via the input unit 1201 (a step S209) and the process proceeds to S205.

Information treated in this embodiment will be described below and afterward, the details of each unit of the resource management plan creation support device 1000 will be described.

In a field of the operation information 1, a march is defined every minimum unit of transport service. For example, the minimum unit of transport service in a railroad is a train and is defined by stations at which the train stops or passes among a starting station and a terminal station, arrival time, departure time or passing time of each station.

In a field of the resource information 2, transportation used for transport service is defined. For example, the resource information in a railroad is information that defines a vehicle. Concretely, the resource information in the railroad includes a vehicle name or an identification number for uniquely identifying the vehicle, whether maintenance work (inspection, cleaning and others) is to be executed on that day of operation, executable time of the maintenance work, a location in which the maintenance work is to be executed and a course identification number for uniquely identifying transport service (equivalent to a train in the railroad) allocated to the vehicle.

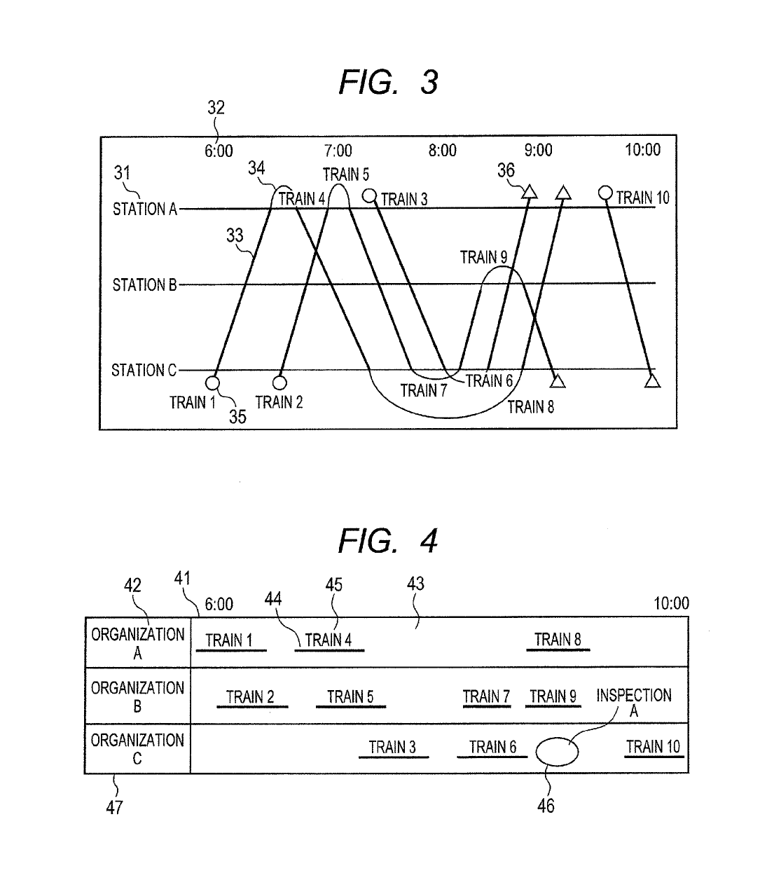

In a field of the course information 3, it is defined in what order one transportation executes the minimum unit of transport service. For example, in a case of a railroad, the course information is equivalent to a list of train information allocated to one vehicle in consideration of the shuttle service of the vehicle, storage and pulling in/out of a car depot (see FIG. 3). The train information means a train name or train ID for uniquely identifying the corresponding train. For example, FIG. 3 shows how trains are allocated to each four vehicle. That is, one vehicle is allocated to the trains 1, 4 and 8, another vehicle is allocated to the trains 2, 5, 7 and 9, further another vehicle is allocated to the trains 3 and 6, and furthermore another vehicle is allocated to the train 10.

The history information 4 means the history of changes applied to a result of a plan created by the resource management plan creation support device 1000 by users in the past. The details will be described in the description of “the acceptance of a change” in the step S209.

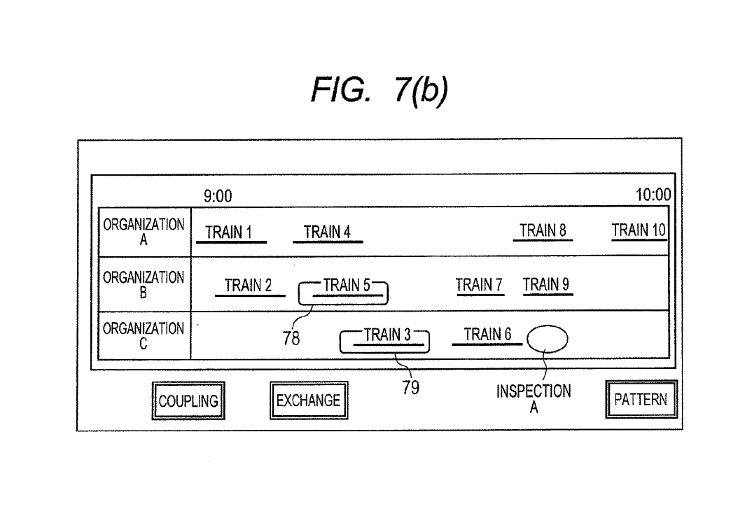

Referring to FIGS. 3 and 4, target service in this embodiment will be described, referring to FIGS. 5(a) and 5(b), models of the resource management plan will be described, and referring to FIGS. 7(a) to 9, the details and the operation of each unit of the resource management plan creation support device 1000 will be described below. In this embodiment, for an example to which the present invention is applied, service of the arrangement of vehicular operation performed when the operation of a railroad is disturbed is supposed. The arrangement of vehicular operation means service that the allocation of a vehicle to a train is changed in accordance with a changed operational schedule when an operational schedule of a train because of an accident and the failure of a vehicle is suddenly changed. There are a means to change the allocation of a vehicle includes a means to change a train to be allocated at a station for a turn, a means to provisionally pull out a spare train stored in a car depot and a means to provisionally store a vehicle in the car depot. Further, it is provided in law that regular inspection should be applied to a vehicle according to the number of travel kilometers and travel days. In the arrangement of vehicular operation, to change the allocation of vehicles, the above-mentioned means are combined also in consideration of the execution of inspection determined not to exceed a period of inspection.

### <Description of Service>

FIGS. 3 and 4 show charts used in the transport service of a railroad and data used for an example in this embodiment.

FIG. 3 shows an operational schedule of trains. An initial drawing of FIG. 3 is created based upon the operation information 1 and after the execution of “the creation of the resource management plan” in S206, FIG. 3 is created based upon a plan creation result.

An axis of ordinates 31 shows a station and an axis of abscissas 32 shows time.

One train is represented by drawing a line from a starting station to a terminal station of the train according to time. For example, a thick line 33 represents one train that leaves the station C about six o'clock and arrives at the station A about six thirty.

A line segment that connects two train lines such as a line segment 34 represents a group of trains allocated to one vehicle. For example, in an example shown in FIG. 3, the trains 1, 4 and 8 are connected as a series of trains and the example means that one vehicle is run in the order of these.

A mark represented by O such as a sign 35 shows timing at which a vehicle is pulled out of a car depot. For example, the sign 35 shows that a vehicle is pulled out of a car depot adjacent to the station C for the departure of the train 1.

As a sign 36, a mark represented by Δ shows timing at which the vehicle is stored in the car depot. For example, the sign 36 shows that after the train 6 arrives, a vehicle allocated to the train 6 is stored in a car depot adjacent to the station A. FIG. 4 shows the allocation of the trains to each train set. The train set means a set of plural vehicles allocated to the trains. An initial drawing of FIG. 4 is created based upon the resource information 2 and the course information 3 and after the execution of “the creation of the resource management plan” in S206, FIG. 4 is created based upon the plan creation result. FIG. 4 includes an axis of abscissas 41, a name of the train set 42 and allocation information 43.

The axis 41 shows time.

The name of the train set 42 shows a name for uniquely identifying the train set.

The allocation information 43 shows the allocation of trains to the train set shown in the train set 42. One bar (for example, a bar 44) shows allocated each train and a name of the train (for example, a train name 45) is shown near to the bar. Further, in a case of the train set in which maintenance work such as cleaning and inspection is scheduled, a sign representing the scheduled work is shown. For example, a sign 46 shows that after the train set C is run as the train 6, maintenance work of inspection A is scheduled to be done.

A series of course information shown in a record 47 will be described using the record 47 for one example below. The record 47 shows a course allocated to the train set C and shows that after the train set C is run as the train 3, it is run as the train 6 and after work of the inspection A is done, the train set is run as the train 10. FIG. 3 shows that the train 6 is stored in the car depot adjacent to the station A after running and the train 10 is pulled out of the car depot adjacent to the station A. Therefore, it is known that after the train set C is once stored in the car depot after the train set C is run as the trains 3 and 6, the train set C is pulled out of the car depot again and is run as the train 10.

### <Network Model>

FIGS. 5(a) and 5(b) show network models of the resource management plan used in the present invention. FIG. 5(a) shows the network model showing operation information and FIG. 5(b) shows the network model showing spare operation. Two divided figures FIGS. 5(a) and 5(b) are used for convenience, however, in the creation of the resource management plan, FIGS. 5(a) and 5(b) are synthesized and are treated as one network model.

In an example shown in FIG. 5, some links are omitted for simplicity.

FIG. 5(a) shows the network model representing a candidate of a course and includes a train set node, a train node, an end node, a connection link and an end link.
(1) Train Set Node

The train set node represents a train set to which a course is allocated. One train set node is set per train set. The train set node has start time in a time zone in which the train set is available, termination time in a time zone in which the train set is available, a position in which the train set is put at operation start time (a station adjacent to a put car depot or a put station), a starting station of a course in an original plan and a terminal station of the course in the original plan as an attribute.
(2) Train Node

The train node represents a train included in an operational schedule. One train node is set per one train. The train node has a starting station, a terminal station, start time and termination time of a train as an attribute.
(3) End Node

The end node represents an end of a course. One end node is set per one train set. The end node has a train set name or train set ID for uniquely identifying a train set and a terminal station of a course planned in an original plan as an attribute. For example, the end node 51 represents an end of a course of the train set A. In the example shown in FIG. 4, an end of a course in an original plan of the train set A is the train 8 and in the example shown in FIG. 3, the train 8 arrives at the station A. Therefore, a value of an attribute of the terminal station of the end node 51 is the station A.
(4) Connection Link

The connection link means an oriented link that links the train nodes, the train set node and the train node, and the train node and the end node and is created as follows.

### (How to Link Train Nodes)

The connection link between the train nodes is generated based upon a starting station, start time, a terminal station and termination time of a train respectively represented by the train node so that the time and the connection of the stations are met. For example, the train node 53 represents the train 1, a starting station is the station C, a terminal station is the station A, start time is six o'clock, and termination time is six thirty. Further, the node 54 represents the train 4, a starting station is the station A, a terminal station is the station C, start time is six forty, and termination time is seven five. As the terminal station of the node 53 is equivalent to the starting station of the node 54 when these two train nodes are compared, the connection of locations is met. Since the termination time of the node 53 is earlier than the start time of the node 54, the connection of time is met. Therefore, the connection link from the node 53 to the node 54 can be created. Similarly, connection links from the node 53 to a node representing the train 5, a node representing the train 3 and a node representing the train 10 can be created.

A weight that facilitates selection as solution compared with the other connection link is set to the connection link between the trains continuously allocated in the same train set in the original resource management plan. For example, though the details are described later, a course is created by searching a round route in which the weight of the link in the networks shown in FIG. 5 is small in this embodiment. Therefore, a weight of a small value is set to the connection link between the trains continuously allocated to the same train set in the original resource management plan. Hereby, a plan having as few changes from the original plan as possible can be acquired. The following description of a weight that facilitates selection as a connection link has the same meaning.

### (How to Link Train Node and Train Set Node)

The connection link between the train node and the train set node is created based upon a starting station, start time, a terminal station and termination time of the train represented by the train node, start time and termination time in a time zone in which the train set represented by the train set node is available and a position of the train set at operation start time so that the connection of the time and the location is met. For example, as an available time zone of the train set (the train set A) represented by the train set node 52 is six o'clock and a starting position is the station C, a connection link from the train set node 52 toward the train node representing the train that leaves the station C since six o'clock is created. That is, the connection link toward each train node respectively representing the trains 1, 2, 6, 8 is created.

A weight that facilitates selection as solution compared with the other link is set to the connection link showing the same allocation as the connection link in the original resource management plan.

### (How to Link Train Node and End Node)

The connection link between the train node and the end node is created from the train node that can be set as a final train of a course toward the end node. The train that can be set as the final train of the course basically means a train that finally arrives at a station adjacent to a car depot or at a station at which the train can stay in its station yard till the next day. In the meantime, a case that the train is redirected to store in a car depot is not desirable.

A weight that facilitates selection as solution compared with the other link is set to a connection link between a train node representing a train at the end of a course in the original plan and an end node.
(5) End Link

The end link is a link for restricting so that a course is terminated at a point scheduled in the original resource management plan of the train set. The end link is created from one end node toward all train set nodes and a weight is set based upon the restriction of the course termination point. That is, a value of a terminal station in the original resource management plan held by the end node and a value of a terminal station in the corresponding resource management plan held by the train set node are compared and when the values are the same, a weight value is set to the end link that links the corresponding end node and the corresponding train set node so as to facilitate selection compared with the end link from the corresponding end node to the other train set node.

For example, a case that a link of a smaller weight is selected is supposed. At this time, the end node 51 represents an end of a course of the train set A and a terminal station in the original plan is the station A. A node representing the train set A is the train set node 52 and a terminal station in the original plan is the station A. Since the terminal station of the end node 51 and the terminal station of the train set node 52 are the same, a smaller value than the link extended from the end node 51 to the other train set node is set to the end link that links the end node 51 and the train set node 52. Further, the end node 55 represents an end of a course of the train set B and since it is known from FIG. 4 that the train 9 is a final train of the course of the train set B, its terminal station is the station C. Since an end of a course of the train set C is also the station C, a weight of the same value is set to both the end link between the end node 55 and the train set node 57 representing the train set B and the end link between the end node 55 and the train set node 58 representing the train set C. Even if the train allocated at the end of the course is different from that in the original resource management plan, the possibility that the trains having the same terminal station are allocated can be enhanced by setting the weight to the end links as described above.

FIG. 5(b) shows a network model representing spare train set. The spare train set means train set to which no course is allocated in the original plan and which is scheduled to be left in a car depot all day. A course may be allocated to the train set as a special train, however, basically, the train set should stay in the car depot. Therefore, it is desirable that the train set is returned to the car depot within an operation arrangement period. When the spare train set is not required to be returned to the car depot within the operation arrangement period, it shall be represented as a train set node shown in FIG. 5(a). For one example of the spare train set, a train set configured by a train to which a vehicle required to be returned to an original location in a predetermined period and owned by another company is allocated can be given in addition to the train set configured by the above-mentioned special train.

FIG. 5(b) includes a train set node for a spare, an end node for a spare, a train node for a spare, a connection link, an end link and a train node.

The train node is the same as that described in FIG. 5(a).
(1) Train Set Node for Spare

The train set node for a spare is a node representing spare train set and one train set node for the spare is set per one spare train set. The train set node for the spare has a station adjacent to a put car depot, start time and termination time in a time zone in which the spare train set can be pulled out of the car depot as an attribute.
(2) Train Node for Spare

A train node for a spare is a node representing spare operation and is set by the number of spare train sets. The train node for the spare has a station adjacent to the car depot, start time and termination time in a time zone in which a vehicle can be stored in the car depot as an attribute.
(3) End Node for Spare

An end node for a spare is a node representing an end of a course of spare train set. The end node for the spare has a train set name or train set ID for uniquely identifying spare train set and a station adjacent of the car depot as an attribute.
(4) Connection Link

A connection link is a link that links the train set node for the spare and the train node for the spare, the train node for the spare and the end node for the spare, the train set node for the spare and the train node, and the train node and the train node for the spare, and the connection link is generated as follows.

### (How to Link Train Set Node for Spare and Train Node For Spare)

A connection link from the train set node for the spare to the train node for the spare is generated from the train set node for the spare to the train node for the spare if only respective attribute values held as an adjacent station of the car depot are the same. A weight that facilitates the selection of solution, compared with the other connection link is set to the connection link.

### (How to Link Train Node For Spare and End Node For Spare)

A connection link from the train node for the spare to the end node for the spare is generated from the train node for the spare to the end node for the spare if only respective attribute values held as an adjacent station of the car depot are the same. The connection link to the end node for the spare is limited to the link from the train node for the spare.

A course including only three of the train set node for the spare, the train node for the spare and the end node for the spare represents that the spare train set is left in the car depot as it is.

### (Generation of Connection Link Between Train Set Node for Spare and Train Node)

A connection link between the train node and the train set node for the spare is generated from the train set node for the spare to the train node based upon a starting station, start time, a terminal station and termination time which are respectively attributes of the train node, a station adjacent to the car depot which is an attribute of the train set node for the spare, start time and termination time in a time zone in which the spare train set can be pulled out of the car depot so that the connection of the time and the locations is met.

### (How to Link Train Node and Train Node for Spare)

A connection link between the train node and the train node for the spare is generated from the train node to the train node for the spare when a terminal station of the train node and a station adjacent to the car depot which is an attribute of the train node for the spare are equal and termination time of the train node is in a vehicle storage possible time zone which is an attribute of the train node for the spare.
(5) End Link

An end link is generated from the end node for the spare to the train set node for the spare if only values which the end node for the spare and the train set node for the spare respectively hold as an adjacent station of the car depot are the same. The end link is generated only from the end node for the spare to the train set node for the spare and no end link is generated from the end node for the spare to the other train set node.

As described above, for the end node for the spare, only the connection link from the train node for the spare is generated and only the end link to the train set node for the spare is generated from the end node for the spare. Hereby, a plan in which the spare train set is necessarily returned to the car depot put as a spare even if the spare train set is extraordinarily used can be created by generating a round route having the train set node for the spare as a starting point.

### <Operational Pattern>

In this embodiment, an operational pattern is generated based upon a change applied to the resource management plan by a user and is reflected in the above-mentioned network model. The operational pattern represents a well-known device of a resource management method and includes partial changes which users repeatedly apply to the resource management plan. In the present invention, the operational pattern is classified in the following two types.
(1) Connection

One operational pattern is a pattern for specifying a set of trains continuously allocated to one train set. For example, specification that the train 7 is allocated after the train 4 and next, the train 9 is allocated means that the trains 4, 7 and 9 are all allocated to the same train set in the specified order and no other train is allocated between these trains.
(2) Exchange

The other operational pattern is a pattern that respectively allocated trains are exchanged between the two train sets. For example, the train 5 is allocated to the train set B, the train 3 is allocated to the train set C, and specification that the train 5 and the train 3 should be exchanged means that the train 5 is allocated to the train set C and the train 3 is allocated to the train set B.

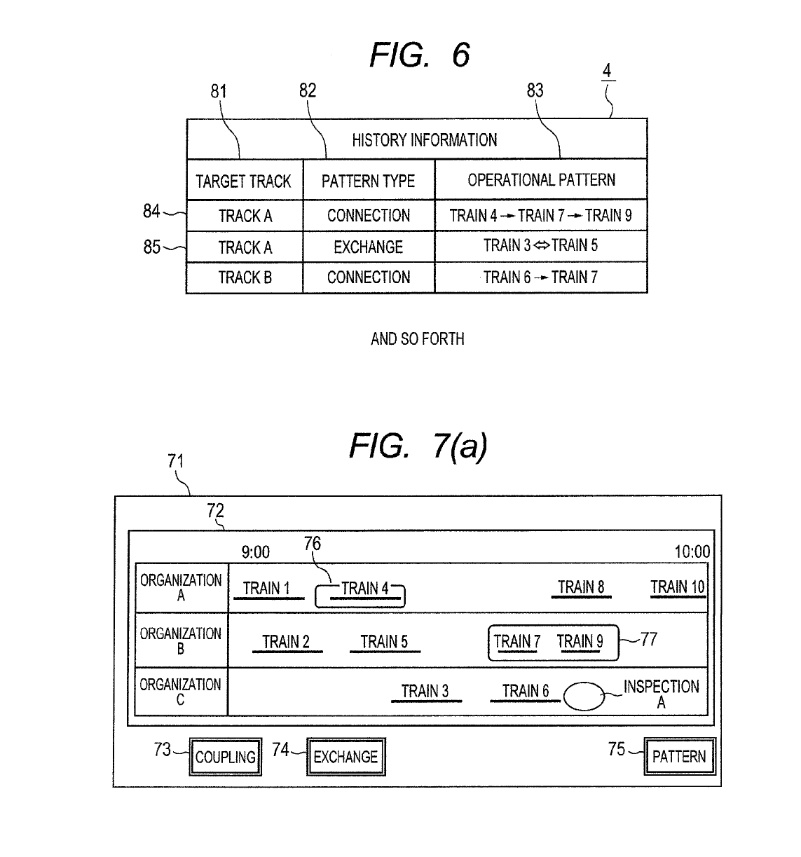

The operational pattern is stored in a field of the history information 4. The history information 4 will be described using FIG. 6 below.

The history information 4 is configured by items of a target track 81, a pattern type 82 and an operational pattern 83.

The target track 81 is a track name or track ID for uniquely identifying a track to which the corresponding operational pattern is applied. The track means a route based upon which the operation of trains is collectively managed.

The pattern type 82 is a pattern name or pattern ID for uniquely identifying the classification of operational patterns.

The operational pattern 83 is detailed information of the operational pattern. Concretely, when the operational pattern is “connection”, a train name or train ID for uniquely identifying a target train and the order of target trains are stored. An example where the example in which the operational pattern is “connection” is stored in the history information is shown in a record 84. Further, when the operational pattern is “exchange”, the train name or the train ID for uniquely identifying the target train is stored. An example where the example in which the operational pattern is “exchange” is stored in the history information is shown in a record 85.

A method of accepting these operational patterns will be described in the description of “Accept change” in the step S209 in FIG. 2 below.

In this embodiment, the resource management plan is created using the above-mentioned network model. The details of a procedure for creating the resource management plan will be described below.

Referring to FIG. 2, the details of a procedure of the resource management plan creation support device 1000 will be described below.

In the step S201, the operational schedule reader 1003 reads the operation information 1 stored in the storage 1100.

In the step S202, the network generating program 1005 generates the network models shown in FIG. 5 based upon the operation information read in S201. The details of a procedure for generating the network models will be described using FIG. 8 below.

In the step S203, the operational history reader 1004 reads the history information 4 stored in the storage 1100.

In the step S204, the operational history reader 1004 proceeds to “Creation of resource management plan (the step S206)” when no history information exists and proceeds to “Reflect operational pattern (the step S205)” when history information exists.

In the step S205, the operational pattern generating program 1008 changes the network model generated by the network generating program in S202 based upon the operational history read by the operational history reader 1004 in S203. A method of changing will be described below.
(1) When Operational Pattern is “Connection”

A node representing a target train is extracted and a value that facilitates selection is set as the weight of a link that links each node. For example, when the resource management plan is created by searching a path in which a weight for a link in a network is as small as possible, a smaller value than a value currently set as a weight between nodes of target trains is set.
(2) When Operational Pattern is “Exchange”

As for two trains to be target trains, a node representing the target train and nodes representing trains allocated before and after the target train out of trains allocated to the same train set as the target train are extracted (respectively called a prior operational train node and a posterior operational train node). The weight of a link between a prior operational train node of the other target train and a train node of the other target train out of the respective target trains and the weight of a link between a posterior operational train node of the other target train and the train node of the target train are set to values that more facilitate the selection of the link than currently set values. In this case, when the target train is the first of a course, a train set node having a connection link with the target train node is extracted in place of the prior operational train node and when the target train is the last of the course, an end node having a connection link with the target train node is extracted in place of the posterior operational train node and the similar process is performed.

For example, a case that a link having a smaller weight is apt to be selected is supposed. When the train 5 and the train 3 are exchanged in the plan shown in FIG. 4, a node representing the train 2 as a prior operational train node of the train 5 is extracted from the network model and the weight of a connection link from the extracted node (in this case, the node representing the train 2) to a node representing the train 3 is changed to a smaller value than a currently set value. Further, a node representing the train 7 as a posterior operational train node of the train 5 is extracted from the network model and the weight of a connection link to the node (in this case, the node representing the train 7) extracted from the node representing the train 3 is changed to a smaller value than a currently set value. Also as to the train 3, the weight of a connection link is changed; however, since the train 3 is the first train of a course, a node representing the train set C in place of a prior operational train is extracted and the weight of a connection link from the extracted node (in this case, the node representing the train set C) to the node representing the train 5 is changed to a smaller value than a currently set value. Further, a node representing the train 6 is extracted as a posterior operational train node of the train 3 and the weight of a connection link from the node representing the train 5 to the extracted node (in this case, the node representing the train 5) is changed to a smaller value than a currently set value.

In the step S206, the plan creating program 1006 creates a resource management plan based upon the network model generated by executing S201 to S205 or the network model generated by executing S205 after S209. A detailed procedure will be described in the description of FIG. 9 below.

In the step S207, the plan creating program 1006 presents the plan created in S206 to a user.

In the step S208, the plan creating program 1006 determines whether the user instructs to finish the creation of the plan or not and when the plan creating program instructs to finish, it stores a result of the creation of the plan in the storage 1100, finishes a series of processing, and when the plan creating program does not instruct to finish, the process proceeds to the acceptance of a change in the step S209.

In the step S209, the change accepting program 1007 accepts a change from the user for the plan presented to the user by the plan creating program 1006 in S207, generates history information, and stores it in a field of the history information 4 in the storage 1100.

Referring to FIG. 7(a), the configuration of a screen for accepting the change will be described below. The screen for acceptance includes a screen frame 71, a vehicle allocation chart 72, a coupling specification button 73, an exchange specification button 74 and a pattern setting button 75. The screen for acceptance is generated by the change accepting program 1007 and is displayed on the display 1200.

The screen frame 71 is a screen frame of the screen for acceptance.

The vehicle allocation chart 72 shows the resource management plan created in S206. The details of the chart are similar to the description in relation to FIG. 4. The user specifies the train to which the user applies a change via the chart.

The coupling specification button 73 is a button for the user to specify that a type of the operational pattern is “connection”.

The exchange specification button 74 is a button for the user to specify that the type of the operational pattern is “exchange”.

The pattern setting button 75 is a button for the user to instruct so that the operational pattern is generated.

An example of input to the screen for acceptance will be described below.

An example that the operational pattern is “connection” is shown in FIG. 7(a). For example, when an operational pattern in which the train 4, the train 7 and the train 9 are allocated to one train set is generated, the corresponding trains are specified as input 76 and input 77, then, the coupling specification button 73 is pressed, and finally, the pattern setting button 75 is pressed. The specification of the trains and the pressure of the buttons are accepted via an input device such as a mouse and a stylus.

An example that an operational pattern is “exchange” is shown in FIG. 7(b). For example, when the train sets to which the train 5 and the train 3 are allocated are exchanged, the corresponding trains are specified as input 78 and input 79, then, the exchange specification button 74 is pressed, and finally, the pattern setting button 75 is pressed. The specification of the trains and the pressure of the buttons are accepted via the input device such as a mouse and a stylus.

Detailed procedures for the generation of the network model in the step S202 and the creation of the resource management plan in the step S206 will be described below. The creation procedure of the network model in the step S202 will be described using FIG. 8.

In a step S601, the network generating program 1005 reads the course information 3 stored in the storage 1100.

In a step S602, the network generating program 1005 reads the resource information 2 stored in the storage 1100.

In a step S603, the network generating program 1005 divides the course information read in S601 into the trains, generates a train node every train, extracts an attribute which each train has from the course information, and allocates the attribute to the train node of the corresponding train. The details of the train node and the attribute allocated to the train node are the same as the description of the network models shown in FIG. 5. Further, in S603, identification information used for a train name of a train in the course information is given as identification information of the train node of the corresponding train.

In a step S604, the network generating program 1005 generates a train set node, an end node, a train set node for a spare, a train node for a spare and an end node for a spare based upon the resource information read in S602 and gives identification information and an attribute of the corresponding node to each node. The details (attributes and others) of these nodes are similar to the description of the network models shown in FIG. 5.

In a step S605, the network generating program 1005 selects one out of the nodes generated in S603 and S604.

In a step S606, the network generating program 1005 determines whether the node selected in S605 is the end node or the end node for the spare, the process proceeds to the generation of an end link in a step S607 when the selected node is the end node or the end node for the spare, and the process proceeds to the generation of a connection link in a step S609 when the selected node is neither the end node nor the end node for the spare.

In the step S607 and a step S608, the network generating program 1005 classifies into a case that the node selected in S605 is the end node and a case that the node selected in S605 is the end node for the spare, and performs the generation of the end link (or the end node for the spare) (S607) and setting the weight of the end link (S608) as follows.

### (Case of End Node)

In the step S607, an end link (an end link 1) to the train set node having the same terminal station as a terminal station in the original plan which is one of attributes of the node selected in S605 is generated based upon the node selected in S605. Further, an end link (an end link 2) to the remaining train set node is generated based upon the node selected in S605.

In the step S608, a weight is set to the end link 1 and the end link 2 respectively generated in S607. A weighted value is set to the end link 1 so that the end link 1 is more easily selected than the end link 2 in the creation of the resource management plan.

### (Case of End Node for Spare)

In the step S607, the train set node for the spare in which “the station adjacent to the car depot” held as an attribute is the same as that of the node selected in S605 is extracted and an end link from the node selected in S605 to the extracted node is generated.

In the step S608, a weight is set to the end link generated in S607. A weighted value is set to the end link so that the end link is more easily selected than the other link linked to the end node for the spare in the creation of the resource management plan.

In the step S609, the network generating program 1005 generates a connection link from the node selected in S605 to a connectable node based upon comparison in a starting station, start time, a terminal station and termination time. The details are similar to the description of the network models shown in FIGS. 5(a) and 5(b).

In a step S610, the network generating program 1005 sets a weight for the connection link generated in S609. When linked two nodes are continuously allocated to the same train set in the original plan, a weighted value is set to the corresponding link so that the link is more easily selected than the other link connected to at least one of the two nodes in the creation of the resource management plan.

In a step S611, the network generating program 1005 determines whether processing in S607 to S608 or S609 to S610 is applied to all the nodes generated in S603 and S604, when the processing is applied, the series of processing is finished, and when the processing is not applied, the process proceeds to S605.

Referring to FIG. 9, a procedure for creating the resource management plan in S206 will be described below.

In a step S901, the plan creating program 1006 temporarily removes the train set node for the spare, the train node for the spare and the end node for the spare from the network model generated by the series of processing in S201 to S205 or in S205 after S209. This aims to create the plan with as little use of the spare train set as possible.

In a step S902, the plan creating program 1006 temporarily removes the end link having a larger weight than a fixed value from the network model as a result of the processing in S901. This aims to create such a plan that a terminal station of a course of each train set is the same as that in the original plan.

In a step S903, the plan creating program 1006 searches a round route (that is, a route that returns to a starting node without passing any node two or more times except the starting node) based upon the network model as the result of the processing in S901 to S902. The generated round route is a closed circuit that starts at the train set node and returns to the train set node through the end node or a closed circuit that starts at the train set node for the spare and returns to the train set node for the spare through the end node for the spare because of the contour of the network model.

In a step S904, the plan creating program 1006 searches a set of round routes that cover all the nodes only once (called a round route set) out of plural round routes generated in S903. That is, the plan creating program searches the solution of the following set partitioning problem.

### <Constant>

$$[ Mathematical expression 1 ]$$

$${a}_{ij} = \{ \frac{1 \text{:} Node i is included in round route j}{0 \text{:} Others} \} \qquad$$

wⱼ: Sum of weights of links included in round route j

N: Sum of train sets

### <Decision Variable>

$$[ Mathematical expression 2 ] \\ {x}_{j} = \{ \frac{1 \text{:} Round route j is included in solution}{0 \text{:} Others} \} \qquad$$

### <Objective Function>

min Σ_{jεR}wⱼxⱼ [Mathematical expression 3]

R: Set of candidate round routes

### <Condition>

[Mathematical expression 4]

Σ_{jεR}αᵢⱼxⱼ=1 (1)

Σ_{jεR}Xⱼ=N (2)

The objection function means that such a set of round routes that the sum of weights is minimum is obtained, the condition (1) means that each node is included in only one round route in the set of round routes to be solution, and the condition (2) means that the round routes included in the set of round routes to be the solution exist by the number of train sets. As a round route that includes two or more train set nodes may be generated in S903, the condition (2) is required to be set so as to prevent such a round route from being selected.

In a case of formulation by the set partitioning problem, a condition that one train set is allocated to only one course may be added, however, as the train set is also represented as a node in the network model in the present invention, the condition is included in the above-mentioned conditions.

Each round route included in the obtained set of round routes becomes a course allocated to the train set represented by the train set node included in the round route.

In a step S905, the plan creating program 1006 determines whether the solution is acquired in the search in S904, when the solution is acquired, the process proceeds to determination in S906, and when no solution is acquired, the process proceeds to determination in S910.

In the step S906, the plan creating program 1006 determines whether the end link having a larger weight than a fixed value is included in the solution acquired in S904, when the corresponding end link is included, the process proceeds to S907, and when no corresponding end link is included, the process proceeds to S912. The fixed value of the weight shall be the same value as the fixed used in S902. This is processing to determine whether such a train set that a terminal station of a course is different from a terminal station in the original plan is included in the solution.

In the step S907, the plan creating program 1006 stores the solution acquired in S904 in the storage 1100 as a candidate of the resource management plan.

In a step S908, the plan creating program 1006 determines whether S903 and S904 are executed in a state in which the train set node for the spare, the train node for the spare and the end node for the spare respectively temporarily removed in S901 are included, when the steps are not executed with the nodes included, the process proceeds to S909, and when the steps are executed with the nodes included, the process proceeds to S912.

In the step S909, the plan creating program 1006 returns the train set node for the spare, the train node for the spare and the end node for the spare respectively removed in S901 to the network model.

In a step S910, the plan creating program 1006 determines whether S903 and S904 are executed in a state in which the link temporarily removed in S902 is included, when the steps are not executed with the link included, the process proceeds to S911, and when the steps are executed with the link included, the process proceeds to the step S908.

In the step S911, the plan creating program 1006 returns the link removed in S902 to the network model.

In the step S912, the plan creating program 1006 stores the solution acquired in S904 in the storage 1100 as a candidate of the resource management plan and terminates a series of processing.

The above-mentioned is the description of the first embodiment.

### Second Embodiment

In the first embodiment, a plan of maintenance work applied to resources such as inspection and cleaning is not considered. In a second embodiment, a case that a resource management plan including the plan of maintenance work is created will be described. In the following description, the description of the similar configuration to the configuration in the first embodiment is omitted and the difference from the first embodiment will be described.

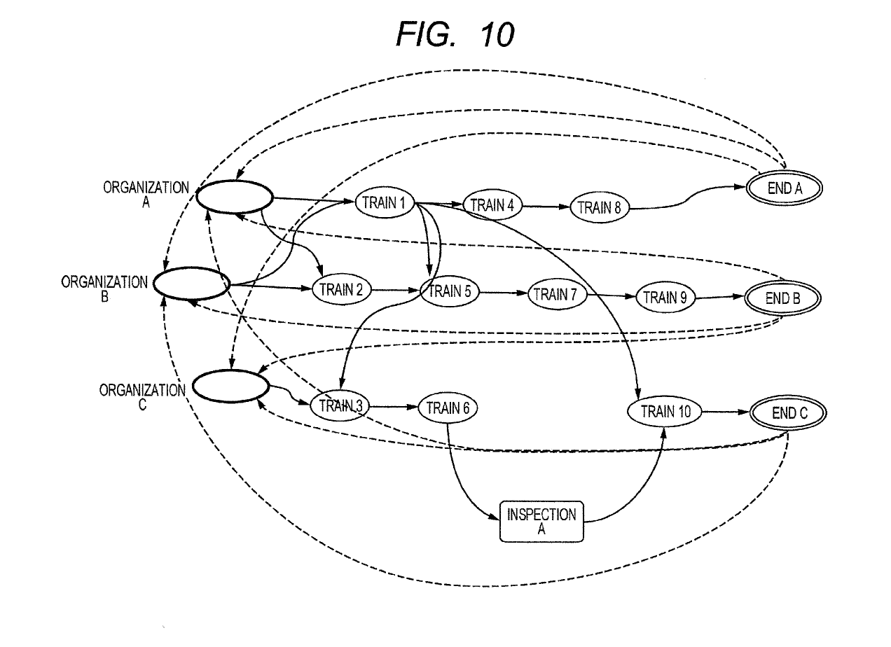

FIG. 10 shows an example of a network model of the resource management plan including maintenance work. The network model is generated by adding a maintenance work node representing maintenance work to the network model shown in FIG. 5(a) in the first embodiment.

The maintenance work node has a maintenance work name or maintenance work ID for uniquely identifying maintenance work represented by the node, maintenance work required time, start time and termination time in a time zone in which the maintenance work can be performed and a station adjacent to a car depot in which the maintenance work can be performed as an attribute.

A maintenance work node is added by connecting the maintenance work node and a train node with a connection link as follows.

(Connection Link from Train Node to Maintenance Work Node)

When start time in a time zone in which maintenance work can be performed is earlier than the final arrival time of a train and an adjacent station of a car depot in which the maintenance work can be performed is equal to a terminal station of a train node, a connection link from the train node to the maintenance work node is generated.

(Connection Link from Maintenance Work Node to Train Node)

Afterward, a train the final arrival time of which is the earliest and a train the final arrival time of which is the latest are selected out of train nodes having the connection link to the maintenance work node and values acquired by adding maintenance work required time to the respective final arrival times are set as a criterion of the shortest time and the longest time of maintenance work termination time. When start time of the train node is between the shortest time and the longest time and the adjacent station of the car depot in which maintenance work can be performed is equal to a starting station of the train node, a connection link from the maintenance work node to the train node is generated.

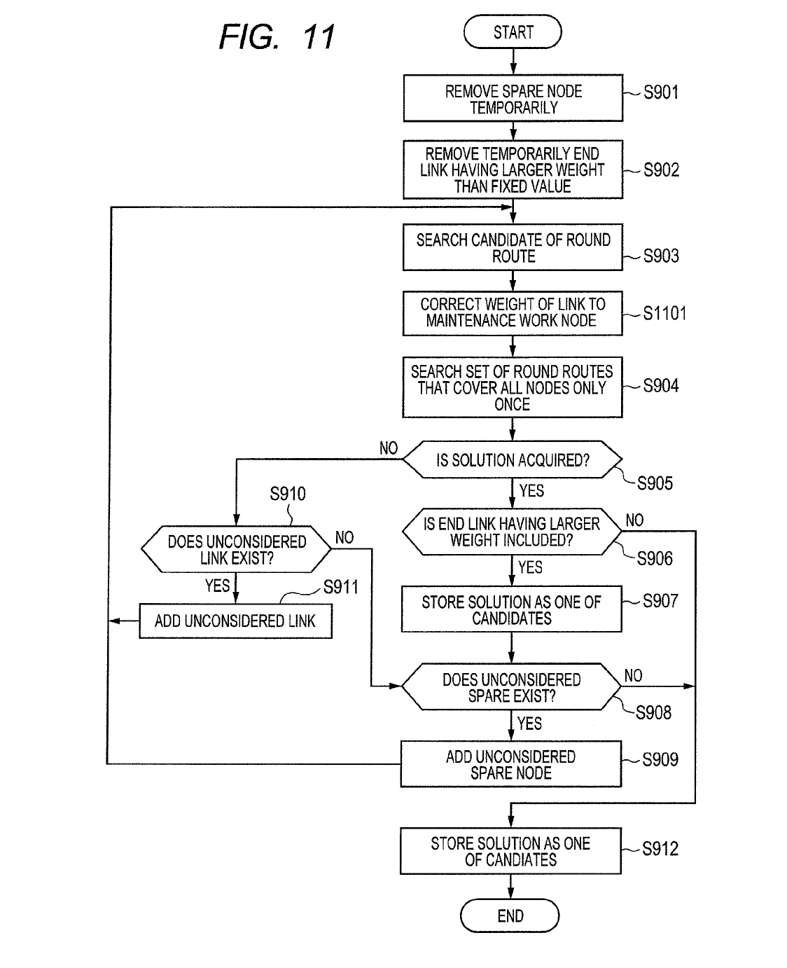

In this embodiment, as in the first embodiment, the resource management plan is also created by obtaining a round route in the network model generated as described above. This process is shown in FIG. 11. However, a train set that passes a maintenance work node cannot be controlled only by generating the round route in the network model. Then, to create such a plan that maintenance work is applied to a determined train set as much as possible, a round route including a train set in which the execution of maintenance work is scheduled is extracted out of candidates of round routes and weights of all connection links to maintenance work nodes are reset to values make the selection of them easier than the other connection link.

Further, to possibly secure required time of maintenance work, train nodes (called a prior train node and a posterior train node) before and after the maintenance work node are extracted from the round route including the maintenance work node and it is determined whether difference between final arrival time of the prior train node and start time of the posterior train node is larger than the required time of the maintenance work. When the difference between the times is smaller than the required time as a result of determination, weights of connection links that link the maintenance work node with the prior train node and the posterior train node respectively are reset to values that make the selection of them more difficult than currently set weight values.

The above-mentioned resets of the weights are performed after the candidate of the round route is generated in S903 in the first embodiment (a step S1101 shown in FIG. 11).

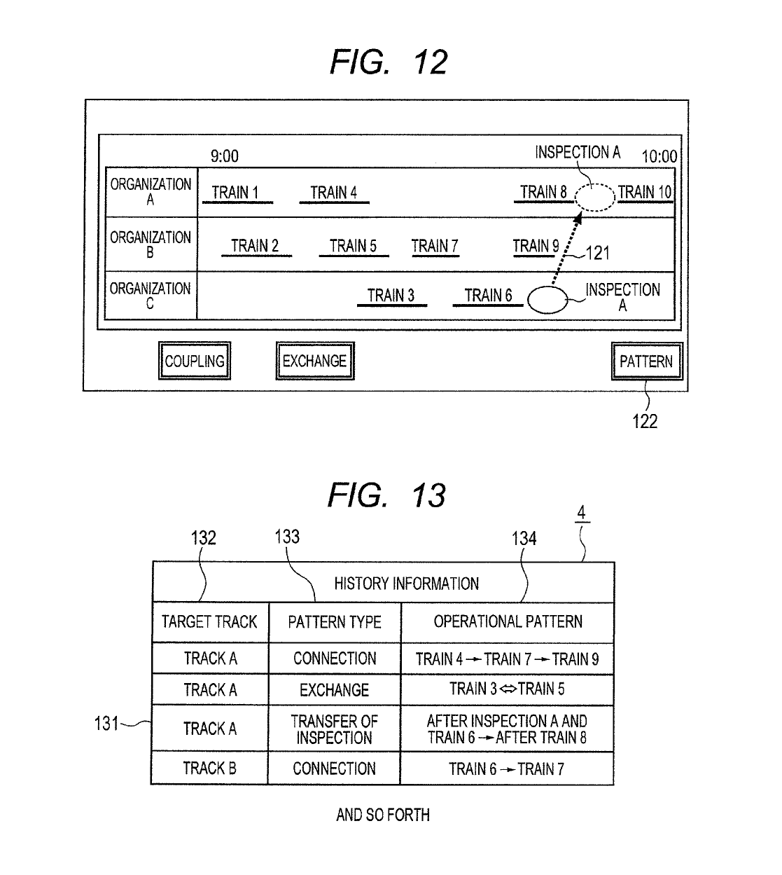

Referring to FIGS. 12 and 13, an operational pattern related to maintenance work will be described below.

One pattern (the transfer of inspection) related to maintenance work is added to the operational patterns described in relation to FIG. 6 and total three types are extracted from operational history of a user as operational patterns. The transfer of inspection represents a pattern that the work is transferred to the other train set to which the same maintenance work is required to be applied immediately close when maintenance work which is scheduled to be applied to a certain train set cannot be executed.

FIG. 12 shows an example of a screen for accepting an operational pattern related to maintenance work. The configuration of the screen is similar to that shown in FIG. 7, a position of a source of exchange and a position of a destination of the exchange are input by moving a sign representing maintenance work from a train set in which the execution of the maintenance work is scheduled to another train set like input 121, and history information is generated by pressing a pattern setting button 122. In this case, “the position” denotes information showing before or after which train maintenance work is to be performed and concretely, the position is represented by a train name or train ID for identifying a train to be a criterion and whether the maintenance work is to be performed before or after the train to be the criterion.

FIG. 13 shows an example of the history information. Components of the history information are similar to those shown in FIG. 6. In a record 131, an example of an operational pattern related to maintenance work is shown. A track to be a target of the operational pattern is stored in a field of a target track 132, “the transfer of inspection” showing that the operational pattern is a maintenance work transfer pattern is stored in a field of a pattern type 133, and a work name or work ID for uniquely identifying maintenance work to which the operational pattern is applied, a train name or train ID for uniquely identifying a train equivalent to a source of transfer and an inspection execution position, a train name or train ID for uniquely identifying a train equivalent to a destination of the transfer and an inspection execution position are stored in a field of the operational pattern 134. The inspection execution position in this case means information for specifying which of before or after the specified train the maintenance work is to be performed.

### DESCRIPTION OF REFERENCE NUMERALS AND SIGNS

### 1000. RESOURCE MANAGEMENT PLAN CREATION SUPPORT DEVICE

### 1001. MEMORY

### 1002. PROGRAM

### 1003. OPERATIONAL SCHEDULE READER

### 1004. OPERATIONAL HISTORY READER

### 1005. NETWORK GENERATING PROGRAM

### 1006. PLAN CREATING PROGRAM

### 1007. CHANGE ACCEPTING PROGRAM

### 1008. OPERATIONAL PATTERN GENERATING PROGRAM

### 1100. STORAGE

### 1200. DISPLAY

### 1201. INPUT UNIT

### 1202. CPU

1203. COMMUNICATION UNIT

What is claimed is:

1. A resource management plan creation method, comprising the steps, executed by a computer, of:
reading operation schedule information of transport service;
generating nodes at least having a starting location, start time, a terminal location and termination time of a transportation course as an attribute in each of a plurality of transportation courses included in an operational schedule based upon the operation schedule information, generating a path that connects nodes representing the transportation course in which continuous operation is possible using the same transportation resource based upon the attribute of each node, and generating a network model of the transportation courses;
acquiring information related to spare resources, generating a spare resource node at least having a storage location and an available time zone of the corresponding spare resource as an attribute and adding the spare resource node to the network model and adding a path that connects a node representing an operational course in which operation is possible using the spare resource and the spare resource node based upon the attribute of the spare resource node and an attribute of another node configuring the network model to the network model;
extracting, from the network model, a combination of a plurality of paths in each of which one transportation resource or the spare resource is allocated to each node configuring the network model except the spare resource node; and
creating a management plan of transportation resources and spare resources by allocating the transportation resource or the spare resource to each of the plurality of paths configuring the extracted combination and outputting the management plan.

2. The resource management plan creation method according to claim 1,
wherein the spare resource means a transportation resource owned by another company except a transport service company that owns the transportation resources and provides the transport service; and
the spare resource node is connected to another node so that when the spare resource is moved out of the storage location, it is returned to the storage location on the same day.

3. The resource management plan creation support method according to claim 1,
wherein the network model further includes a maintenance node at least having working hours and a working location of maintenance work of the transportation resource as an attribute; and
the maintenance node is connected to a node representing an operational course in which the transportation resource can be maintained based upon the attribute of the maintenance node.

4. The resource management plan creation method according to claim 1, further comprising the steps, executed by a computer, of:
accepting a change for the operation schedule information; and
changing the network model based upon the accepted change.

5. The resource management plan creation method according to claim 4, further comprising the steps, executed by a computer, of:
storing the contents of the accepted change for the operation schedule information in a storage as an operational pattern; and
reading the operational pattern stored in the storage when the network model is generated and reflecting the operational pattern in the network model.

6. The resource management plan creation method according to claim 1,
wherein the operational schedule is an operational schedule of a train; and
the transportation resource is a vehicle.

7. A resource management plan creation device that creates a management plan of transportation resources, comprising:
an input unit via which a computer reads operation schedule information of transport service;
a network model generating unit that generates a node at least having a starting location, start time, a terminal location and termination time of a transportation course as an attribute in each of a plurality of transportation courses included in an operational schedule based upon the operation schedule information, generates a path that connects nodes representing a transportation course in which continuous operation is possible using the same transportation resource based upon the attribute of each node, and generates a network model of the transportation courses; and
a plan creating unit that creates the management plan based upon the network model,
wherein the network model generating unit acquires information related to spare resources, generates a spare resource node at least having a storage location and an available time zone of the spare resource as an attribute and adds the spare resource node to the network model, and adds a path that connects a node representing an operational course in which operation is possible using the spare resource and the spare resource node based upon the attribute of the spare resource node and an attribute of another node configuring the network model to the network model;
the plan creating unit extracts, from the network model, a combination of a plurality of paths in each of which one transportation resource or the spare resource is allocated to each node configuring the network model except the spare resource node; and
the management plan of transportation resources and spare resources is created by allocating the transportation resource or the spare resource to each of the plurality of paths configuring the extracted combination and the management plan is output.

8. The resource management plan creation device according to claim 7,
wherein the spare resource means a transportation resource owned by another company except a transport service company that owns the transportation resources and provides the transport service; and
the network model generating unit connects the spare resource node to another node so as to return the spare resource to the storage location on the same day when the spare resource is moved out of the storage location.

9. The resource management plan creation device according to claim 7, wherein the network model generating unit further adds a maintenance node at least having working hours and a working location of maintenance work of the transportation resource as an attribute to the network model and generates a path that connects a node representing a transportation course in which the transportation resource can be maintained and the maintenance node based upon the attribute of the maintenance node.

10. The resource management plan creation device according to claim 7,
wherein the computer further accepts a change for the operation schedule information via the input unit; and
the network model generating unit changes the network model based upon the accepted change.

11. The resource management plan creation device according to claim 10, further comprising:
an operational history storage that stores the contents of the change for the operation schedule information accepted via the input unit as an operational pattern,
wherein the network model generating unit reflects, in the network model, the operational pattern stored in the operational history storage when the network model is generated.

12. The resource management plan creation device according to claim 7,
wherein the operational schedule is an operational schedule of a train; and
the transportation resource is a vehicle.
